(19) United States
(12) Patent Application Publication
(10) Pub. No.: US 2026/0145779 A1
(43) Pub. Date: May 28, 2026

(54) MULTI-SLOT OPEN SECTION SLAT TRACK CONFIGURATION

(71) Applicant: THE BOEING COMPANY, Arlington, VA (US)

(72) Inventors: Caroline E. Hartel, Seattle, WA (US); Ramon A. Burin, Lake Stevens, WA (US); Gregory Santini, Bothell, WA (US); Walter Kent von Scheliha, Kirkland, WA (US); Samuel L. Block, Bothell, WA (US); Hugh William Nesti, West Chester, PA (US)

(73) Assignee: THE BOEING COMPANY, Arlington, VA (US)

(21) Appl. No.: 18/956,927

(22) Filed: Nov. 22, 2024

(51) Int. Cl. B64C 13/32

(52) U.S. Cl. CPC B64C 9/02; B64C 9/24

(57) ABSTRACT

A slat support apparatus and a slat track for an aerodynamic surface of an aircraft. The slat support apparatus includes at least one support rib member fixedly coupled in the aircraft wing, a slat track body to advance the slat relative to the aerodynamic surface between a stowed position and a deployed position, a slat track body including a pair of spaced-apart slot openings; and a pair of support rollers fixedly coupled to the at least one support rib member and arranged in the pair of spaced-apart slot openings to support the slat track body for movement along an arcuate path of travel along a longitudinal axis of the slat track body between a retracted position that maintains the slat in the stowed position and an extended position that advances the slat away from the aerodynamic surface.

### FIELD

A slat support apparatus having a multi-slot open section slat track with a compact structural configuration.

### BACKGROUND

Aircraft include one or more control surfaces that impact aerodynamic performance of the aircraft. Slats are control surfaces provided at a leading edge of an aircraft wing for movement between a stowed position and an extended, deployed position away from the aircraft wing. Contemporary slat designs include a slat track that is coupled between a plurality of upper rollers and lower rollers positioned above and below the slat track to facilitate rotation of the slat between the stowed position and the extended, deployed position.

### SUMMARY

A control surface (e.g., a slat) and a slat support apparatus having a multi-slot open section slat track. The slat support apparatus has a structural configuration with a reduced height when compared to contemporary slat designs, and thus, is for implementation in structural configurations of thin-wing aircraft.

The slat support apparatus has a slat track body that includes a pair of open sections defined by an upper flange portion, a lower flange portion, and one or more stiffener portions that extend between the upper flange portion and a lower flange portion. An intermediate stiffener portion separates the open sections and limits deflections at the open sections. Comparatively, the relative size/width of material which forms the lower flange is greater than that which forms the upper flange. Such a structural configuration advantageously facilitates a more compact configuration of the slat track body while also providing a more stiffened slot. Moreover, such a structural configuration is structurally efficient for a slotted track having an upper flange and a lower flange.

The slat track body is supported by support rollers that are arranged through the middle of the slat track body. Each support roller is aligned to a corresponding slot in the slat track body. Location of the support rollers in the middle of the slat track body reduces the height of the slat support apparatus, thereby facilitating thin wing integration. The open sections in the middle of the slat track body enables the support rollers to be supported on both sides of the slat track body, which reduces the slat track width for reduced blocked airflow.

In an exemplary embodiment, a slat track is provided for a control surface (e.g., a slat) of an aircraft, and includes one or more of the following: a slat track body to advance the control surface relative to the aircraft wing between a stowed position and a deployed position, the elongated slat track body including a pair of spaced-apart slot openings; and a pair of support rollers arranged in the pair of spaced-apart slot openings to support the elongated slat track body for movement along an arcuate path of travel along a longitudinal axis of the elongated slat track body between a retracted position that maintains the control surface in the stowed position and an extended position that advances the slat away from the aerodynamic surface.

In accordance with the slat track, the pair of spaced-apart slot openings includes a forward slot opening and an aft slot opening and the pair of support rollers include a forward support roller positioned in the forward slot opening and an aft support roller positioned in the aft slot opening. The forward support roller is positioned in the forward slot opening for rotational engagement with the elongated slat track body, and the aft support roller is positioned in the aft slot opening for rotational engagement with the elongated slat track body.

In accordance with the slat track, the slat track body comprises an upper flange portion, a lower flange portion, and one or more stiffener portions that extend between the upper flange portion and a lower flange portion. The stiffener portions include an intermediate stiffener portion oriented in a substantially perpendicular direction relative to a longitudinal axis of the slat track body. The intermediate stiffener portion is oriented so as to separate the forward slot opening and the aft slot opening. The forward slot opening, the aft slot opening, the forward support roller, and the aft support roller share a center point of the arcuate path of travel (i.e., an arc center point).

In an exemplary embodiment, a slat connection assembly is provided to connect a slat to an aerodynamic surface of an aircraft, and includes one or more of the following: at least one support rib member fixedly coupled in the aerodynamic surface; a slat track body to advance the slat relative to the aerodynamic surface between a stowed position and a deployed position, the elongated slat track body including a pair of spaced-apart slot openings; and a pair of support rollers fixedly coupled to the at least one support rib member and arranged in the pair of spaced-apart slot openings to support the elongated slat track body for movement along an arcuate path of travel along a longitudinal axis of the elongated slat track body between a retracted position that maintains the slat in the stowed position and an extended position that advances the slat away from the aerodynamic surface.

In accordance with the slat connection assembly, the pair of spaced-apart slot openings includes a forward slot opening and an aft slot opening and the pair of support rollers include a forward support roller positioned in the forward slot opening and an aft support roller positioned in the aft slot opening. The forward support roller is positioned in the forward slot opening for rotational engagement with the elongated slat track body, and the aft support roller is positioned in the aft slot opening for rotational engagement with the elongated slat track body.

In accordance with the slat connection assembly, the slat track body comprises an upper flange portion, a lower flange portion, and one or more stiffener portions that extend between the upper flange portion and a lower flange portion. The stiffener portions include an intermediate stiffener portion oriented in a substantially perpendicular direction relative to a longitudinal axis of the slat track body. The intermediate stiffener portion is oriented so as to separate the forward slot opening and the aft slot opening. The forward slot opening, the aft slot opening, the forward support roller, and the aft support roller share a center point of the arcuate path of travel (i.e., an arc center point).

### DRAWINGS

The various advantages of the examples of the present disclosure will become apparent to one skilled in the art by reading the following specification and appended claims, and by referencing the following drawings, in which:

FIG. 1 illustrates a top view of an aerodynamic surface of an aircraft having one or more control surfaces.

FIG. 2 illustrates a side sectional view of the aerodynamic surface of FIG. 1.

FIG. 3 illustrates a perspective view of an advantageous embodiment of a slat support apparatus for the slat of FIG. 1.

FIG. 4 illustrates a side, sectional view of the slat support apparatus of FIG. 1, with the slat track in a retracted position.

FIG. 5 illustrates a side, sectional view of the slat support apparatus of FIG. 1, with the slat track in an extended position.

FIG. 6 illustrates a front view of the slat track of FIGS. 4 and 5.

FIG. 7 illustrates an exemplary embodiment of a method of manufacturing a slat track for an aircraft wing.

FIG. 8 illustrates an exemplary embodiment of a method of manufacturing a control surface of an aircraft.

FIG. 9 illustrates an exemplary embodiment of a method of operating a control surface of an aircraft.

### DESCRIPTION

Examples set forth herein provide an enhanced multi-slot open section slat track for a control surface of an aircraft, a control surface (e.g., a slat) for an aerodynamic surface of an aircraft, and a support apparatus for such a control surface, the support apparatus having a multi-slot open section slat track. The slat support apparatus has a structural configuration with a reduced height when compared to contemporary slat support designs, and thus, is for implementation in aircraft thin-wing structural configurations.

The slat support apparatus has a slat track body that includes a pair of open sections defined by an upper flange portion, a lower flange portion, and one or more stiffener portions that extend between the upper flange portion and a lower flange portion. An intermediate stiffener portion separates the open sections and limits deflections at the open sections.

The slat track body is supported by support rollers that are arranged through the middle of the slat track body. Each support roller is aligned to a corresponding slot in the slat track body. Location of the support rollers in the middle of the slat track body reduces the height of the slat support apparatus, thereby facilitating thin wing integration. The open sections in the middle of the slat track body enables the support rollers to be supported on both sides of the slat track body, which reduces the slat track width for reduced blocked airflow.

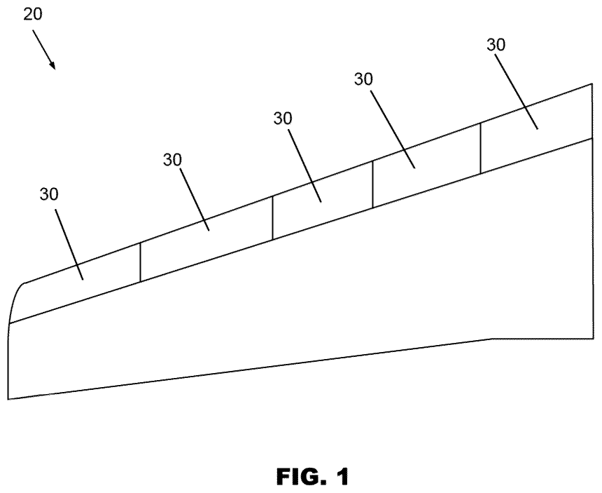

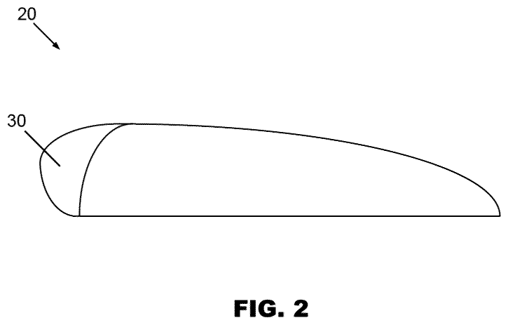

In the illustrated exemplary embodiment of FIGS. 1 and 2, an aerodynamic surface, such as aircraft wing 20, includes a plurality of control surfaces such as a slat 30 that is movable relative to the aerodynamic surface between a stowed position and a deployed position.

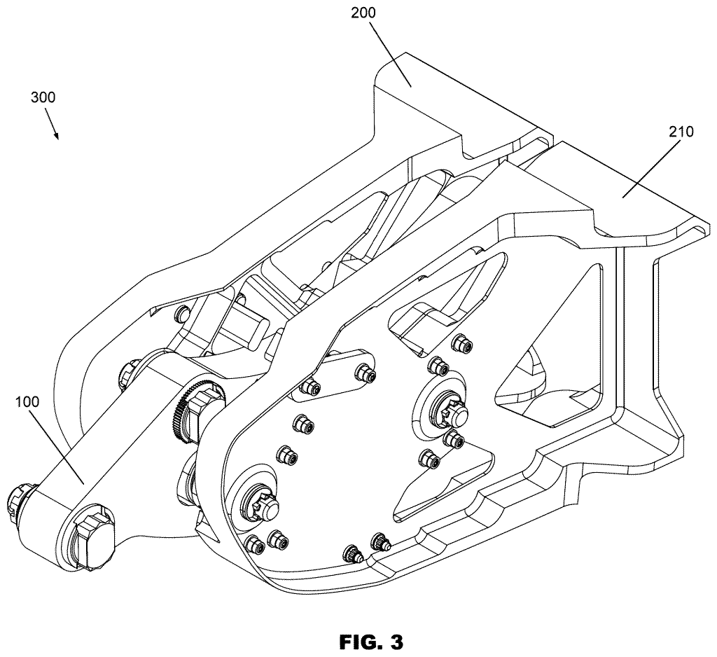

In the illustrated exemplary embodiment of FIG. 3, the slat support apparatus 300 includes at least one support rib member 200, 210 fixedly coupled to the aerodynamic surface (e.g., aircraft wing 20), a slat track 100 having an elongated slat track body 110, and a pair of support rollers 220, 221 fixedly coupled to the at least one support rib member 200, 210. and an elongated slat track body 110 movably coupled to the pair of support rollers 220, 221 to advance the slat relative to an aerodynamic surface such as the aircraft wing 20 between the stowed position and the deployed position.

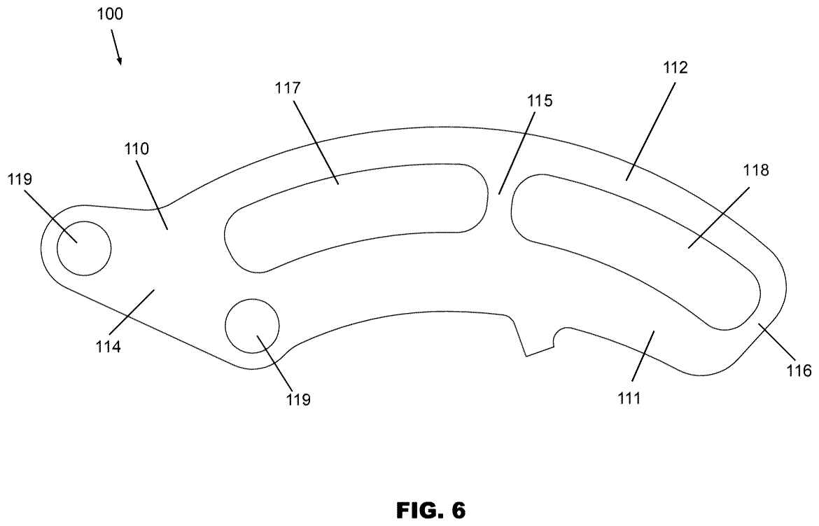

In the illustrated exemplary embodiment of FIG. 6, the slat track body 110 comprises an upper flange portion 111, a lower flange portion 112, and a plurality of stiffener portions 114, 115, and 116 that extend between the upper flange portion 111 and the lower flange portion 112. The plurality of stiffener portions 114, 115, and 116 include a forward stiffener portion 114, an intermediate stiffener portion 115, and an aft stiffener portion 116 that define spaced-apart slot openings includes a forward slot opening 117 and an aft slot opening 118. The forward slot opening 117 and the aft slot opening 118 have an arcuate shape that substantially corresponds to the arcuate path of travel. Comparatively, the relative size/width of material which forms the lower flange portion 112 is greater than that which forms the upper flange portion 111. Such a structural configuration advantageously facilitates a more compact configuration of the slat track body 110 while also providing greater stiffness at the forward slot opening 117 and the aft slot opening 118. Moreover, such a structural configuration is structurally efficient for a slat track body 110 having an upper flange portion 111 and a lower flange portion 112.

A slat track body 110 structural configuration that includes the forward stiffener portion 114, the intermediate stiffener portion 115, and the aft stiffener portion 116 enables a transfer of the axial/shear loads between the upper flange portion 111 and the lower flange portion 112.

The intermediate stiffener portion 115 is oriented in a substantially perpendicular direction relative to a longitudinal axis of the slat track body 110 to separate the forward slot opening 117 and the aft slot opening 118. The intermediate stiffener portion 115 advantageously limits track deflections of the forward slot opening 117 and the aft slot opening 118. In operation, axial/shear loads are applied to the upper flange portion 111 in a first direction, and axial/shear loads are applied to the lower flange portion 112 in a direction opposite to the first direction.

A forward region of the elongated slat track body 110 includes one or more fastener aperture or through-holes 119 that facilitate one or more connection regions between the elongated slat track body 110 to the slat 30. At least one of the connection regions is outside of a fixed leading edge body to further facilitate compact configuration within the fixed leading edge body.

The slat track body 110 may be formed in whole or in part of a material that exhibits high-strength and high stiffness. Such a durable material can comprise a high-strength steel or a steel alloy, such as, for example 4340 steel. Such Embodiments, however, are not limited thereto. This disclosure contemplates forming the slat track body 110 of any suitable material that falls within the spirit and scope of the principles of this disclosure.

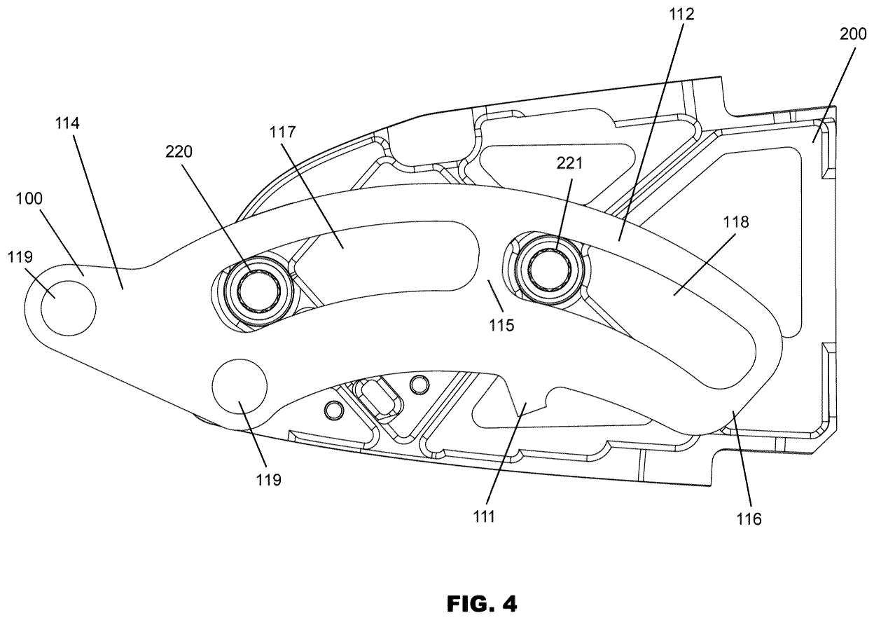

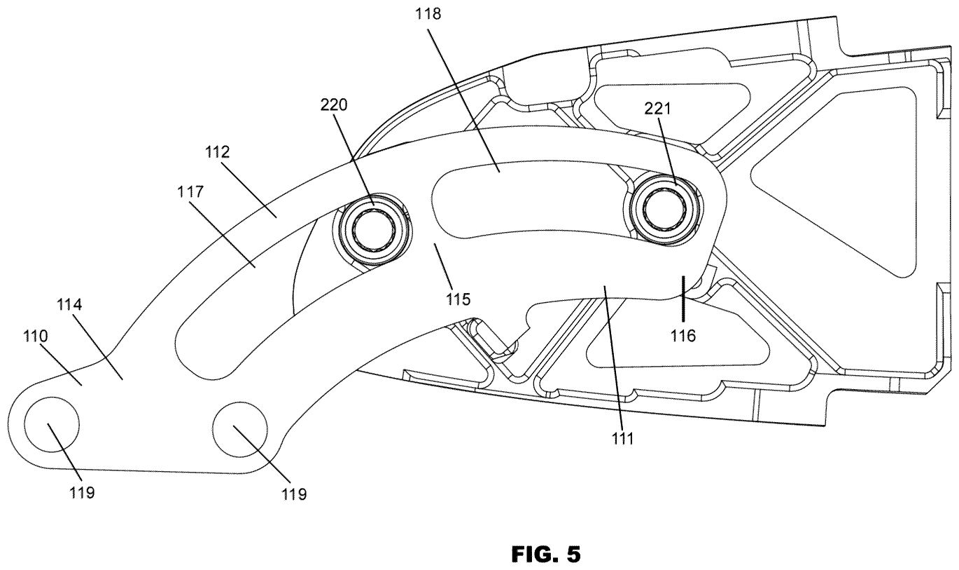

In the illustrated exemplary embodiment of FIGS. 4 and 5, the pair of support rollers 220, 221 are fixedly coupled to at least one support rib member 200, 210. The pair of support rollers 220, 221 include a forward support roller 220 positioned in the forward slot opening 117 and an aft support roller 221 positioned in the aft slot opening 118 to support the elongated slat track body 110 for movement along an arcuate path of travel along a longitudinal axis of the elongated slat track body 110 between a retracted position (See FIG. 5) that maintains the slat 30 in the stowed position and an extended position (See FIG. 6) that advances the slat away from the aerodynamic surface/aircraft wing 20. Particularly, the forward support roller 220 is positioned in the forward slot opening 117 for rotational engagement with the elongated slat track body 110 and the aft support roller 221 is positioned in the aft slot opening 118 for rotational engagement with the elongated slat track body 110 to facilitate movement of the elongated slat track body 110 along the arcuate path of travel. Positioning the forward roller member 220 and the aft roller member 221 in the middle of the elongated slat track body 110 enables integration of the slat support apparatus 300 into thin-wing designs. The forward slot opening 117 and the aft slot opening 118 enable the forward support roller 220 and the aft support roller 221 to be in double shear, thereby reducing stress thereon.

The forward roller member 220 and the aft roller member 221 may respectively comprise a roller bearing or a ball bearing. Embodiments, however, are not limited thereto. This disclosure contemplates the forward roller member 220 and the aft roller member 221 comprising any suitable structural configuration that falls within the spirit and scope of the principles of this disclosure.

The forward slot opening 117, the aft slot opening 118, the forward support roller 220, and the aft support roller 221 share a center point of the arcuate path of travel (arc center point). The forward slot opening 117 and the aft slot opening 118 enable the forward support roller 220, and the aft support roller 221 to be supported on both sides of the elongated slat track body 110, which reduces the overall width of the elongated slat track body 110 (e.g., thus facilitating reduced blocked airflow).

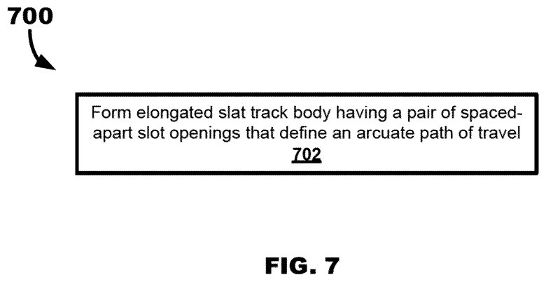

In the illustrated exemplary embodiment of FIG. 7, a method 700 for manufacturing a slat track (e.g., slat track 100) is provided.

Illustrated process block 702 includes forming an elongated slat track body with an upper flange portion (e.g., upper flange portion 111), a lower flange portion (e.g., lower flange portion 112, and at least one stiffener portion (e.g., intermediate stiffener portion 115) that extends between the upper flange portion and the lower flange portion to define a pair of spaced-apart slot openings (e.g., plurality of slot openings 117, 118) that define an arcuate path of travel along a longitudinal axis of the elongated slat track body.

In accordance with process block 702, the pair of spaced-apart slot openings include a forward slot opening and an aft slot opening (e.g., forward slot opening 117 and an aft slot opening 118).

In accordance with process block 702, the stiffener portion is oriented in a substantially perpendicular direction relative to a longitudinal axis of the slat track body.

In accordance with process block 702, the forward slot opening and the aft slot opening have an arcuate shape that substantially corresponds to the arcuate path of travel.

The method 700 can terminate or end after execution of process block 702.

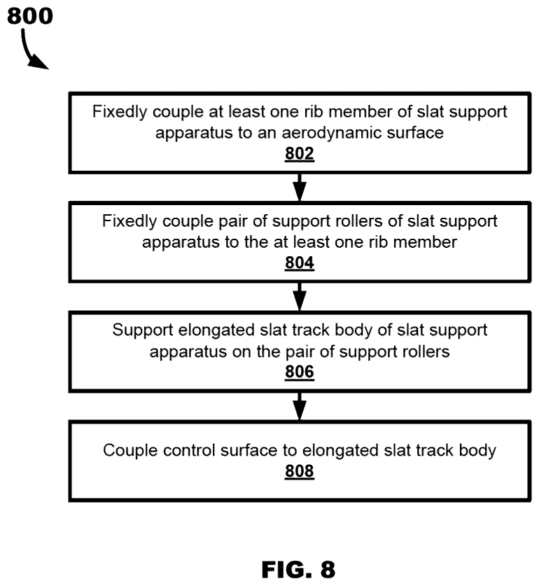

In the illustrated exemplary embodiment of FIG. 8, a method 800 of manufacturing a control surface of an aircraft.

Illustrated process block 802 includes fixedly coupling at least one support rib member (e.g., support rib member 200, 210) of a slat support apparatus (e.g., slat support apparatus 300) to an aerodynamic surface (e.g., aircraft wing 20).

The method 800 may proceed to process block 804, which includes fixedly coupling a pair of support rollers (e.g., pair of support rollers 220, 221) of the slat support apparatus to the at least one support rib member.

In accordance with process block 804, the pair of support rollers include a forward support roller (i.e., forward support roller 220) and an aft support roller (e.g., aft support roller 221).

The method 800 may proceed to process block 806, which includes supporting an elongated slat track body (e.g., elongated slat track body 110) of the slat support apparatus on the pair of support rollers in a manner such that the pair of support rollers are received in a corresponding pair of spaced-apart slot openings (e.g., slot openings 117, 118) of the elongated slat track body 110.

In accordance with process block 806, the slat track body comprises an upper flange portion (e.g., upper flange portion 111), a lower flange portion (e.g., lower flange portion 112), and a stiffener portion (e.g., intermediate stiffener portion 115) that extends between the upper flange portion and lower flange portion.

In accordance with process block 806, the pair of spaced-apart slot openings includes a forward slot opening (e.g., forward slot opening 117) and an aft slot opening (e.g., aft slot opening 118) that define an arcuate path of travel of the slat track body.

In accordance with process block 806, the forward slot opening and the aft slot opening are separated by the stiffener portion.

In accordance with process block 806, supporting the elongated slat track body on the pair of support rollers comprises positioning the forward support roller in the forward slot opening and the aft support roller in the aft slot opening.

In accordance with process block 806, supporting the elongated slat track body on the pair of support rollers comprises aligning the forward slot opening, the aft slot opening, the forward support roller, and the aft support roller along the same center point of the arcuate path of travel of the slat track body.

The method 800 may proceed to process block 808, which includes coupling the control surface to the elongated slat track body.

The method 800 can terminate or end after execution of process block 808.

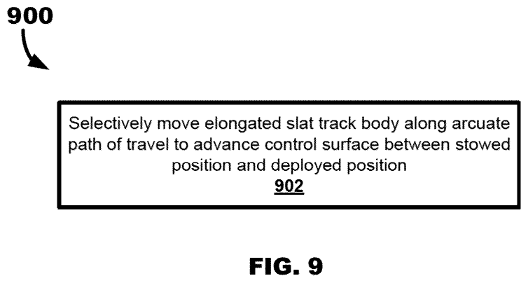

In the illustrated exemplary embodiment of FIG. 9, a method 900 of operating a control surface (manufactured by the method of FIG. 8) an aircraft is provided.

Illustrated process block 902 includes advancing the control surface (e.g., slat 30) away from an aerodynamic surface of the aircraft between a stowed position and a deployed position by selectively moving the elongated slat track body to move along the arcuate path of travel.

The terms “coupled,” “attached,” or “connected” used herein is to refer to any type of relationship, direct or indirect, between the components in question, and is to apply to electrical, mechanical, fluid, optical, electro-magnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner.

Those skilled in the art will appreciate from the foregoing description that the broad techniques of the one or more embodiments of the present disclosure is to be implemented in a variety of forms. Therefore, while the present disclosure describes matters in connection with particular embodiments thereof, the true scope of the embodiments of the present disclosure should not be so limited since other modifications will become apparent to the skilled practitioner upon a study of the drawings, specification, and following claims.

1. A slat track for a control surface of an aircraft, the slat track comprising:
a slat track body to advance the control surface relative to an aerodynamic surface between a stowed position and a deployed position, the slat track body including a pair of spaced-apart slot openings between and through a first side and an opposite second side of the slat track body; and
a pair of support rollers arranged in the pair of spaced-apart slot openings to support the slat track body for movement along an arcuate path of travel along a longitudinal axis of the slat track body between a retracted position that maintains the control surface in the stowed position and an extended position that advances the control surface away from a wing of the aircraft.

2. The slat track of claim 1, wherein the pair of spaced-apart slot openings includes a forward slot opening and an aft slot opening.

3. The slat track of claim 2, wherein the pair of support rollers include a forward support roller positioned in the forward slot opening and an aft support roller positioned in the aft slot opening.

4. The slat track of claim 3, wherein the slat track body comprises an upper flange portion, a lower flange portion, and at least one stiffener portion that extends between the upper flange portion and the lower flange portion.

5. The slat track of claim 4, wherein the stiffener portion is oriented in a perpendicular direction relative to a longitudinal axis of the slat track body.

6. The slat track of claim 4, wherein the forward slot opening and the aft slot opening are separated by the stiffener portion.

7. The slat track of claim 2, wherein the forward slot opening and the aft slot opening, share a center point of the arcuate path of travel.

8. A slat support apparatus, comprising:
at least one support rib member fixedly coupled to an aerodynamic surface of an aircraft;
a slat track body to move a control surface relative to the aerodynamic surface between a stowed position and a deployed position, the slat track body including a pair of spaced-apart slot openings between and through a first side and an opposite second side of the slat track body; and
a pair of support rollers fixedly coupled to the at least one support rib member and arranged in the pair of spaced-apart slot openings to support the slat track body for movement along an arcuate path of travel along a longitudinal axis of the slat track body between a retracted position that maintains the control surface in the stowed position and an extended position that advances the control surface away from a wing of the aircraft.

9. The slat support apparatus of claim 8, wherein the pair of spaced-apart slot openings includes a forward slot opening and an aft slot opening.

10. The slat support apparatus of claim 9, wherein the pair of support rollers include a forward support roller positioned in the forward slot opening and an aft support roller positioned in the aft slot opening.

11. The slat support apparatus of claim 10, wherein the slat track body comprises an upper flange portion, a lower flange portion, and a stiffener portion that extends between the upper flange portion and the lower flange portion.

12. The slat support apparatus of claim 11, wherein the stiffener portion is oriented in a perpendicular direction relative to a longitudinal axis of the slat track body.

13. The slat support apparatus of claim 11, wherein the forward slot opening and the aft slot opening are separated by the stiffener portion.

14. The slat support apparatus of claim 9, wherein the forward slot opening and the aft slot opening share a center point of the arcuate path of travel.

15. A control surface for an aerodynamic surface of an aircraft, the control surface comprising:
a slat movable relative to a wing of the aircraft between a stowed position and a deployed position; and
a slat support apparatus coupled to the slat to advance the slat between the stowed position and the deployed position, the slat support apparatus including at least one support rib member fixedly coupled to an aircraft wing, a slat track body to move a slat relative to the aerodynamic surface between a stowed position and a deployed position, the slat track body including a pair of spaced-apart slot openings between and through a first side and an opposite second side of the slat track body, and a pair of support rollers fixedly coupled to the at least one support rib member and arranged in the pair of spaced-apart slot openings to support the slat track body for movement along an arcuate path of travel along a longitudinal axis of the slat track body between a retracted position that maintains the slat in the stowed position and an extended position that advances the slat away from the aerodynamic surface.

16. The control surface of claim 15, wherein the pair of spaced-apart slot openings includes a forward slot opening and an aft slot opening.

17. The control surface of claim 16, wherein the pair of support rollers include a forward support roller positioned in the forward slot opening and an aft support roller positioned in the aft slot opening.

18. The control surface of claim 17, wherein the slat track body comprises an upper flange portion, a lower flange portion, and a stiffener portion that extends between the upper flange portion and the lower flange portion.

19. The control surface of claim 18, wherein the stiffener portion is oriented in a perpendicular direction relative to a longitudinal axis of the slat track body.

20. The control surface of claim 18, wherein:
the forward slot opening and the aft slot opening are separated by the stiffener portion, and
the forward slot opening and the aft slot opening share a center point of the arcuate path of travel.
